(19) United States
(12) Patent Application Publication
(10) Pub. No.: US 2009/0324786 A1
(43) Pub. Date: Dec. 31, 2009

(54) Underwater Pressure Arc Discharge System for Disinfection of Food and Food Products

(76) Inventor: James L. MCNAUGHTON, Salisbury, MD (US)

Correspondence Address: AMIN Talati, LLC, 444 NORTH ORLEANS STREET, SUITE 400, CHICAGO, IL, 60654, US

(21) Appl. No.: 12/491,872

(22) Filed: Jun. 25, 2009

Related U.S. Application Data
(60) Provisional application No. 61/075,511, filed on Jun. 25, 2008.

(51) Int. Cl. A23L 3/015; A23B 4/00; B65B 55/02

(52) U.S. Cl. 426/234; 422/128; 426/238

(57) ABSTRACT

A method for reducing and/or eliminating bacterial contamination in a food product includes immersing the food product in the tank containing a fluid and discharging a pressure arc beneath the surface of the fluid wherein the pressure arc is effective in disrupting cell equilibrium and/or inactivating the bacteria. A system for use in the method includes an electrical input/output system, a reflector, the reflector reflecting an output charge between two oppositely charged electrodes, and a fluid filled tank. The method and system are effective in the reduction of food-borne bacterial contaminants particularly in or on poultry, red meat, and/or pork.

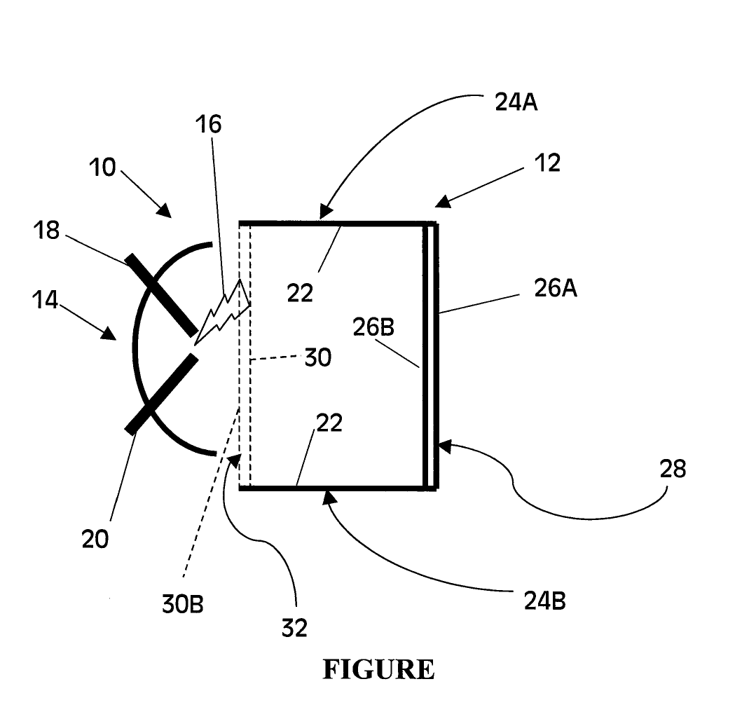

This application claims the benefit of earlier filed U.S. patent application Ser. No. 61/075,511 filed on Jun. 25, 2008.

### FIELD OF INVENTION

The present invention generally relates to an “Underwater Pressure Arc Discharge” system (or UPAD) used to disinfect food products during high-efficiency processing in one or more designated areas during processing. More particularly, the invention is directed to a system and a method used to either partially reduce and/or eliminate bacterial contamination of all species for use in food products such as, for example, poultry, red meat, and pork.

### BACKGROUND OF THE INVENTION

Pressure (or shockwave) has been used by the military for deterrent measures, for tenderness of meat (particularly red meat), and particle size reduction of hard rocks (to expose more gold/silver).

The uses of pressure for food sterilization and tenderization have a long history, however all of the proposed methods have shortcomings, particularly in, but not limited to, practicality of use, ease of implementation and, perhaps most importantly, integrity of the food product after the pressure is applied.

Food sterilization processes have been scrutinized by regulatory agencies for these, and other, reasons. The Food and Drug Administration (FDA/CFSAN) evaluates Alternative Food Processing Technologies outside the scope of chemical application and traditional thermal processes for foods that may be effective in inactivating pathogens of public health concern. FDA/CFSAN in their 2000 report “Kinetics of Microbial Inactivation for Alternative Food Processing Technologies” reviewed and recognized weaknesses in the following “pressure systems: Microwave and Radio Frequency Processing, Ohmic and Inductive Heating, High Pressure Processing, Pulsed Electric Fields, High Voltage Arc Discharge, Oscillating Magnetic Fields, Ultraviolet Light, and Ultrasound.” In this report, the FDA recognized that high hydrostatic pressure may result in high-pressure microbial inactivation for foods for human consumption.

FDA is most concerned about the following bacteria which are known to be responsible for causing food borne disease: A. hydrophila, B. cereus, C. jejuni, C. botulinum, Clostridium perftingens, pathogenic Escherichia coli, Campylobacteria, Listeria monocytogenes, Salmonella spp., Shigella spp, Staphylococcus aureus, Vibrio spp., and Y. enterocolitica.

Bacteria of most concern for poultry processing include, but are not limited to, pathogenic Escherichia coli, Listeria monocytogenes, Campylobacteria, Salmonella spp., and Shigella spp.

These bacteria are of concern from both the public health and shelf-life perspective. One of the unique advantages of high-pressure food processing, in comparison to thermal processing, is that pressure (with and without heat) acts uniformly and instantaneously throughout the mass of the food.

This is extremely important in poultry processing because of the difficulty, for example, in chemicals and wash treatments actually penetrating the biofilm, skin pores, cracks/crevices and especially the hidden characteristics of poultry's internal cavity. Pressure may offer a method of reaching hidden bacteria during practical high-efficiency meat processing applications.

Historically, high-pressure food processing has had high thermal temperatures associated with the process that may cause food damage or premature cooking results that are undesirable to meat processors.

To eliminate these deficiencies, arc discharge is an early application of electricity to pasteurize fluids by applying rapid discharge voltages through an electrode gap below the surface of aqueous suspensions of microorganisms. A multitude of physical effects (intense wave) and chemical compounds (electrolysis) are generated, inactivating the microorganisms. The use of arc discharge for liquid foods may be unsuitable largely because electrolysis and the formation of highly reactive chemicals occur during the discharge.

High-pressure food processing has had some laboratory success in meat processing and whole carcass sanitation. Practical applications have been limited to processing spinach, some produce, raw milk, pasteurizing juice, contaminated water and limited meat processing. Practical applications and equipment needs of high-pressure food processing and high efficiency red meat, pork meat, and poultry processing have not been sufficiently developed.

As USDA regulations become stricter with regard to the presence of Salmonella and other pathogenic bacteria in poultry products, processors are searching for more effective ways to reduce pathogens. If commercial poultry processors are going to accept this technology within the limits of commercial processing systems, the technology alone must accomplish the task of bacteria degradation.

In a Watt Publication, Dr. Scott M. Russell, a University of Georgia Poultry Processing Specialist, indicated “On Apr. 3, 2007, USDA/FSIS New Technology Staff issued a letter to companies that sell and distribute online reprocessing chemistries asking for new monitoring data. Based on the requirement reflected in this letter, companies seeking approval for the use of their chemistries for online reprocessing would have to prove that fecal-contaminated carcasses that have gone through the online reprocessing system are microbiologically equivalent to, or better than, inspection passed carcasses that have gone through the online reprocessing system.”

With existing chemical applications, this is a near impossibility. New technology, most likely one that is of non-chemical nature or combination of chemistry and non-chemical techniques, will be required to meet these new rigorous USDA/FSIS performance standards.

The poultry industry has neither been able to nor found a means of precisely controlling food borne bacteria levels that are harmful to humans. Therefore, USDA/FSIS has mandated standards that are now nearly impossible to meet; essentially these standards will be “Zero Tolerance” or complete carcass sterilization. Expensive chemicals (along with spraying, dipping, fogging, foaming, high nozzle pressure, and others) have historically been unable to meet these USDA standards and especially offer the ultimate goal. Therefore, mechanical means, or combination with well-known chemicals, of bacteria degradation may offer such a means of meeting the ultimate goal of “Zero Tolerance”.

### SUMMARY OF THE INVENTION

A general object is to provide a method and system that uses pressure (or shockwave) to reduce bacterial contamination of food products.

A more specific object is to overcome one or more of the problems discussed above.

In accordance with one embodiment, food products such as poultry, red meat, and/or pork meat are exposed to an underwater electrical discharge during intensive high-efficiency meat processing. The underwater electrical discharge can be used alone, in conjunction with one or more disinfecting agents, or in a heated/hot scald water bath.

In accordance with another embodiment of the invention an underwater pressure arc device or UPAD can be used during continuous online processing/online reprocessing (COP/OLR) and/or offline reprocessing (OLR) such as may be required by USDA/FSIS during poultry processing.

In accordance with a further embodiment, the device or system includes placing a UPAD device, including both electronic components and reflector, onto a specially designed processing tank. The tank can be designed to accommodate the processing of up to 140, or more, birds per minute. The UPAD system can be adapted for processing beef, swine, and other animal products. Processing parameters which may be adjusted and/or varied during processing can include, but are not limited to, charge capacity, discharge strength, wave or arc pressure, and/or charge/recharge intervals.

Suitably, an entire “system” which includes a UPAD device, an appropriate processing tank, and, optionally, any disinfecting solutions or liquids that can provide the ability to perform disinfecting operations in any size processing plant practically and without disruption to normal processing techniques. In its entirety, such system will be referred to as a “UPAD System”.

### BRIEF DESCRIPTION OF THE DRAWINGS

The FIGURE illustrates one configuration for a UPAD device in accordance with the invention.

### DETAILED DESCRIPTION

The invention provides a device and method for reducing and/or eliminating bacteria within meat products while maintaining the integrity of the original product. Bacteria maintain osmotic pressure within the cell that balance equilibrium with external pressure demands. Once either chemicals or external pressure disrupts this equilibrium the cell will either implode or explode. Problematic obstacles have included bacterial resistance and compromising the integrity of the meat product.

The UPAD (Underwater Pulsed Arc Discharge) System provides sufficient pressure on bacteria to either sufficiently weaken or completely destroy bacteria. Although the use of the UPAD System was originally researched primarily in the red meat industry, the application has shown promise for poultry processing and pork processing. Accordingly, a system that adapts the UPAD for use in the high-efficiency poultry processing production systems present in today's USA processing plants is desired.

Unlike chemicals that may be used alone for bacterial disinfection, unique to the application of the UPAD System and method disclosed herein, especially to poultry carcasses, is the ability of pressure generated via an underwater electrical discharge to transcend hidden skin pores, skin cracks/crevices, and internal cavity, regardless of organic matter, hidden location or biofilm protection points, completely weakening and/or destroying bacteria regardless of location. One key to success of the UPAD System is providing sufficient pressure to accomplish the task. In practice the pressure can be combined with a disinfecting agent that can be used to enhance the bacteria-destroying action.

Disinfecting agents may include, but are not limited to: chlorine, ozone, UV disinfection, iodine and quaternary ammonium compounds. In accordance with certain embodiments, the disinfecting agent can be in the form of a liquid or solution which is placed in a tank of the UPAD System.

The underwater pressure discharge device or UPAD is an electrically-charged high-voltage system that in one embodiment can be charged up to about 15 kJoules (e.g., about 0.1 kJ, 2.5 kJ, 3.8 kJ, 5.2 kJ, or 6.7 kJ) electrical energy and which can subsequently discharges a pulse of up to about 50 kAmps (e.g., about 0.1 kAmps, 5 kAmps, 10 kAmps, 15 kAmps, 25 kAmps, 40 kAmps, or 50 kamps) electrical discharge between two oppositely charged electrodes.

Depending on where in the process the pressure arc discharge is applied, a single pulse or multiple pulses can be used for treatment. In varying embodiments, a single treatment lasts anywhere from about 1 second up to, and including, about 3 minutes.

As shown in the FIGURE, the UPAD System 10 includes an electrical input/output system 12 and a reflector 14 that reflects an output charge 16 between two electrodes 18 and 20, respectively, reflecting underwater, in what may be referred to as a shockwave or pressure arc. By discharging an arc, pressure is created and dispersed directly and indirectly by the specially-designed reflector 14 set at appropriate angles for dispersion. In one embodiment, an example of the magnitude of pressure created is between about 30,000 to about 100,000 psi.

The electrical input/output (I/O) System 12 suitably has a stainless steel construction including single stainless steel plates, 22A and 22B, which form sidewalls 24A and 24B of the I/O System 12, and two stainless steel plates 26A and 26B, which form a back wall 28 of the I/O System 12. The I/O system 123 further induces a pair of stainless steel screens 30A and 30B positioned adjacent to the reflector 14 and which form a front wall 32 of the I/O system 12.

In use, the UPAD System 10 is disposed or submerged within a tank (not shown) which can be filled with any suitable liquid medium such as, for example, water, an antibacterial/antimicrobial disinfectant solution, hot scald water or the like. In certain embodiments the liquid medium has a temperature in the range of 32 degrees Fahrenheit to 200 degrees Fahrenheit. Advantageously, the UPAD System 10 can be positioned on and/or within the tank such that the screens 30A and 30B, the reflector 14, and the electrodes 18 and 20 are immediately adjacent to a wall of the tank.

In differing embodiments, the UPAD System 10 can be designed to charge and re-charge at a rate of about one time per second in a continuous manner up to once per 5 seconds. In accordance with certain embodiments the UPAD System 10 can discharge a pressure arc at a rate of about 0.2 pulses per second to about 2 pulses per second.

Historical empirical data has shown that animal carcass meat is both tenderized and sterilized with adequate pressure points. In certain embodiments, the UPAD System 10 can be used for tenderization, sterilization or both.

In one embodiment, the UPAD system 10 may be used during continuous online processing/online reprocessing (COP/OLR) and/or offline reprocessing (OLR) processing of poultry or other meats, just prior to chilling the carcasses. This is particularly beneficial for chickens and turkeys.

In another embodiment, the UPAD system 10 may be used just before and after intestine removal from the carcasses in all animal species, including, but not limited to poultry, red meat and pork.

In another embodiment, the UPAD System 10 may be used on both warm and chilled carcasses in all animal species.

In another embodiment, the UPAD System 10 may be used just after meat processing and prior to packaging or sale.

In another embodiment, the UPAD system 10 may be used following packaging in plastic or similar material.

In yet other embodiments, the UPAD System 10 may be used basically anywhere during meat processing for the sole purpose of carcass/meat bacteria reduction and/or elimination.

A method for processing a food product such as, for example, poultry, pork or red meat products includes the steps of: immersing the food product in an aqueous bath; discharging an electrical pulse into the bath thereby generating a pressure arc; and reducing a bacterial count on the food product.

In accordance with certain embodiments, the food product can be exposed to the pressure arc discharge prior to chilling and/or in the presence of a disinfecting agent. For example, the aqueous bath can include a food grade bactericide such as, for example, chlorine.

As described in greater detail in connection with the example below, one such high-pressure food processing system has had initial success. In the initial study, limitations were found in maximum pressure components; thus, best results were found with the combination of shock pressure, chemicals, and chilling. However, shock pressure alone also demonstrated effectiveness in reducing carcass bacteria.

### EXAMPLE

In accordance with the invention, a preliminary study was conducted using the above described UPAD System. The objective of the preliminary study was to determine the effect of pre-chill shock pressure, with and without the use of a disinfectant in the treatment bath. Bacterial testing was conducted before and after chilling of the carcasses.

Each treatment protocol was administered to 50 chicken carcasses. The UPAD system was charged to a 5 kJoule input pressure. The output charge was in a range of from about 5 kAmps to about 10 kAmps. Testing was conducted to determine the effects of a chlorine wash and/or a pressure arc discharge on E. coli counts, Aerobic Plate Counts (APC) and Salmonella incidence.

The chicken carcasses were subject to one of three protocols: (1) wash only containing 35 ppm chlorine (Cl₂); (2) underwater pressure arc treatment only; and (3) underwater pressure arc delivered in a treatment wash containing 35 ppm (Cl₂). The results of the preliminary study are presented in Table 1, below.

Results indicate that pre-chill shock pressure with and without chlorine usage significantly (P<0.05) reduced pre-chill carcasses bacteria, i.e. bacterial counts were reduced by at least 25% compared to untreated, control carcasses. Further, post-chill reduction was found with both pre-chill washing and pressure shock treatment. Furthermore, the combination of pre-chill washing and pressure shock treatment resulted in near sterilization.

TABLE 1

| | Bacteria Type (Pre-Chill)² | | | Bacteria Type (Post-Chill)² | | |
|---|---|---|---|---|---|---|
| Pre-Chill | Bacteria Type (count per mL) | | Salmonella | Bacteria Type (count per mL) | | Salmonella |
| Treatment | E. coli Count | APC Count | Incidence (%) | E. coli Count | APC Count | Incidence (%) |
| Control (wash only) | 1970^{c 2} | 4230^{c} | 92^{c} | 205^{c} | 530^{c} | 70^{c} |
| Shock Pressure (5 kJ) | 151^{b} | 580^{b} | 12^{b} | 69^{b} | 221^{b} | 6^{b} |
| Shock (5 kJ) + Cl₂ 35 ppm | 36^{a} | 96^{a} | 2^{a} | 1^{a} | 11^{a} | 0^{a} |

¹Each treatment was administered for one shock and, where chlorine used, for 2-4 sec per carcass. Each treatment was administered to 50 carcasses per treatment.
²Means within a column and without a common superscript are significantly (P < 0.05) different as determined by Least Significant Difference.

Additional studies are being to conducted to determine the efficacy of charge outputs of 15, 25 and 35 kAmps and charge inputs as low as 3.8 kjoules to as high as 6.7 kJoules as well as values there between such as, for example, 5.2 kJoules.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

I claim:

1. A method for reducing bacterial contamination in a food product, comprising:
providing a pressure arc discharge system including a tank containing a fluid;
immersing the food product in the tank; and
discharging a pressure arc beneath the surface of the fluid;
wherein a bacterial count on the food product is reduced.

2. The method in accordance with claim 1, wherein the pressure arc has a magnitude of at least about 30,000 pounds per square inch (psi).

3. The method in accordance with claim 1, further comprising generating the pressure arc via an electrical pulse.

4. The method in accordance with claim 3, wherein the electrical pulse has an amplitude of at least about 10 kiloamps (kAmps).

5. The method in accordance with claim 1, wherein the pressure arc is discharged at a rate of about 0.2 pulses per seconds up to about 1 pulses per second.

6. The method in accordance with claim 1, further comprising treating the food product for a period of about 1 seconds up to about 180 seconds.

7. The method in accordance with claim 1, wherein the food product is selected from the group consisting of poultry, red meat, pork meat, and combinations thereof.

8. The method in accordance with claim 1, wherein the bacterial count of at least one species selected from the group consisting of A. hydrophila, B. cereus, C. jejune, C. botulinum, Clostridium perfringens, Escherichia coli, Campylobacteria, Listeria monocytogenes, Salmonella spp., Shigella spp, Staphylococcus aureus, Vibrio spp., Y. enterocolitica, and combinations thereof, is reduced by at least about 25% compared to an untreated food product.

9. The method in accordance with claim 1, wherein the fluid comprises an aqueous solution including a disinfecting agent selected from the group consisting of chlorine, ozone, iodine, quaternary ammonium compounds, and combinations thereof.

10. A pressure arc discharge system for use in the method of claim 1, comprising:
an electrical input/output system; and
a reflector, the reflector reflecting an output charge between two oppositely charged electrodes.

11. The system in accordance with claim 10, wherein the reflector is positioned immediately adjacent a wall of the tank beneath the surface of the fluid.

12. The system in accordance with claim 10, wherein the system is one of integrated with a continuous online processing/online reprocessing (COP/OLR) system or part of an offline reprocessing (OLR) system.

13. The system in accordance with claim 10, wherein the tank has a holding capacity of up to about 140 poultry carcasses.

14. The system in accordance with claim 10 wherein the electrical input/output system comprises a charge capacity of up to about 15 kJoules (kJ).

15. The system in accordance with claim 10, wherein the oppositely charged electrodes discharge an electrical pulse generating a pressure arc having a magnitude of up to about 100,000 psi.

16. A method for reducing bacterial contamination in a food product, comprising:
providing a pressure arc discharge system including a tank containing a disinfecting fluid;
immersing the food product in the tank, the food product selected from the group consisting of meat products, poultry products, and combinations thereof;
generating an electrical pulse having an amplitude of at least about 10 kAmps; and
discharging a pressure arc via the electrical pulse beneath the surface of the fluid for a period of at least about 2 seconds;
wherein a bacterial count on the meat product is reduced by at least about 25% compared to an untreated food product.

17. The method in accordance with claim 16, further comprising treating the meat and/or poultry product at least one of before intestinal removal from a carcass, after intestinal removal from the carcass, a warm carcass, a chilled carcass, prior to meat processing, after meat processing, following packaging, or a combination thereof.

18. The method in accordance with claim 16, wherein the food product is tenderized, sterilized, or a combination thereof.

19. The method in accordance with claim 16, wherein the disinfecting fluid is selected from the group consisting of water, chlorine solutions, ozone, iodine solutions, solutions containing a quaternary ammonium compound, and combinations thereof.

20. The method in accordance with claim 16, wherein the disinfecting fluid has a temperature in a range of about 32° F. to about 200° F.
